(19) United States
(12) Patent Application Publication
(10) Pub. No.: US 2007/0091770 A1
(43) Pub. Date: Apr. 26, 2007

(54) Optical system for collimating elliptical light beam and optical device using the same

(75) Inventor: Wen-Hsin Sun, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry Co., LTD, Tu-Cheng City (TW)

(21) Appl. No.: 11/481,649

(22) Filed: Jul. 5, 2006

(30) Foreign Application Priority Data
Oct. 21, 2005 (CN) 200510100565.8

(51) Int. Cl. G11B 7/00

(52) U.S. Cl. 369/112.24; 369/44.23

(57) ABSTRACT

An optical system (20) for efficiently collimating an elliptical light beam includes a light source (21), a first lens (22), and a second lens (23). The light source is adapted for providing an elliptical light beam defining different diverging angles in different directions, wherein any cross-section of the elliptical light beam emitted from the light source defines a long axis and a short axis which are perpendicular to each other. The first lens and the second lens are used for reconfiguring the elliptical light beam, thus obtaining a round light beam having equivalent short axis and long axis, and equivalent diverging angles in both horizontal direction and vertical direction.

This application is related to copending U.S. utility patent applications Ser. No. 11/131,252, entitled OPTICAL SYSTEM FOR COLLIMATING ELLIPTICAL LIGHT BEAM AND OPTICAL DEVICE USING THE SAME and filed on Dec. 29, 2005, and Ser. No. 11/321,306, entitled OPTICAL SYSTEM FOR COLLIMATING ELLIPTICAL LIGHT BEAM AND OPTICAL DEVICE USING THE SAME filed on Dec. 29, 2005; which are entirely incorporated herein by reference, and a copending application entitled OPTICAL SYSTEM FOR COLLIMATING ELLIPTICAL LIGHT BEAM AND OPTICAL DEVICE USING THE SAME filed on Jun. 14, 2006, and a copending application entitled OPTICAL SYSTEM FOR COLLIMATING ELLIPTICAL LIGHT BEAM AND OPTICAL DEVICE USING THE SAME filed on the same day with the same assignee, which are entirely incorporated herein by reference.

### BACKGROUND OF THE INVENTION

1. Field of the Invention

The present invention relates to an optical system for collimating an elliptical light beam, and particularly to an optical system for efficiently collimating elliptical light beams emitted from a sidelight emitting laser diode and an optical device using the same.

2. Related Art

Optical disks are widely used data storing media, and are being developed to store more information than previous. Since higher data storing density is demanded of optical disks, optical disk reading/writing systems correspondingly need to be more precise and sophisticated.

Referring to FIG. 1, a conventional optical device 100 for providing a collimated parallel round light beam for reading/writing to a recording layer 150 of an optical disk (not shown) is shown. The optical device 100 includes a light source 110, a first round collimating lens 120, a beam splitter 130, an object lens 140, a second round collimating lens 160, and an optoelectronic detector 170. In operation, the light source 110 provides a light beam of a certain wavelength. The light beam is collimated by the first round collimating lens 120 into a parallel light beam. The parallel light beam is then transmitted through the beam splitter 130 to the object lens 140. The object lens 140 converges the parallel light beam to the recording layer 150 of the optical disk. The light beam converged to the recording layer 150 is modulated in accordance with the data recorded thereon or written thereon, and is then reflected by the optical disk back to the object lens 140. The light is then transmitted back to the beam splitter 130, and is then reflected thereby to the second round collimating lens 160. Therefore, the light beam is transmitted to and detected by the optoelectronic detector 170, rather than being transmitted to the light source 110. According to the light beam received, the optoelectronic detector 170 outputs an electronic signal, from which the information recorded on or written to the optical disk can be interpreted or identified.

A typical optical system adopts a sidelight emitting laser diode as a light source. Referring to FIG. 2, such a sidelight emitting laser diode 21 has a rectangular waveguide type resonation cavity. The laser light beam emitted from the resonation cavity has different diverging angles in horizontal directions and vertical directions respectively, and thus provides an elliptical light beam having an elliptical section 112. Typically, the horizontal diverging angle is about ±10° and the vertical diverging angle is about ±30°. An elliptical light beam has to be intercepted or converted to a round light beam for use in the optical system.

In the above-described optical device 100, the round collimating lens 120 is employed for intercepting a round core part 114 of the elliptical light beam and thus obtaining a round light beam. The collimating lens 130 generally has a diameter shorter than a corresponding short (e.g., horizontal) axis of a light spot projected by the elliptical light beam incident thereon. The core part of the elliptical light beam is allowed to pass through the round collimating lens 120, and the peripheral part of the elliptical light beam is dissipated. Referring to FIG. 3, this is a graph of a relationship between diverging angles of the elliptical light beam output by the sidelight emitting laser diode (X-axis) and intensity of light output by the collimating lens 130 (Y-axis). Various different horizontal diverging angles are collectively shown as the line θ_{H}, and various different vertical diverging angles are collectively shown as the line θ_{V}. The space between any two horizontally opposite points on the line θ_{H} represents the round core part of the elliptical light beam that is intercepted by the round collimating lens 120. The horizontal space between each such point and the corresponding point on the line θ_{V} represents a peripheral part of the elliptical light beam that is dissipated. As seen in FIGS. 2 and 3, even if the round collimating lens 120 intercepts the elliptical light beam with a minimal amount of loss of light intensity (i.e. when both of the diverging angles are small), the amount of loss of light intensity is still quite large. Therefore, in general, a sidelight emitting laser diode with high power is needed to compensate for the loss of light intensity. However, high-power laser diodes are not only more costly, but also consume more power.

Therefore, what is needed is an optical system for efficiently collimaing an elliptical light beam.

### SUMMARY

An optical system for efficiently collimating an elliptical light beam includes a light source, a first lens, and a second lens. The light source is adapted for providing an elliptical light beam defining different diverging angles in different directions, wherein any cross-section of the elliptical light beam emitted from the light source defines a long axis and a short axis which are perpendicular to each other. The first lens and the second lens are used for reconfiguring the elliptical light beam, thus obtaining a round light beam having equivalent short axis and long axis, and equivalent diverging angles in both horizontal direction and vertical direction.

An advantage of the optical system is that it can efficiently collimate the elliptical light beam emitting from the light source.

Another advantage is that a light source of relatively low power can be used in the optical system.

### BRIEF DESCRIPTION OF THE DRAWINGS

The above-mentioned and other features and advantages of the optical system, and the manner of attaining them, will become more apparent and the invention will be better understood by reference to the following description of embodiments thereof taken in conjunction with the accompanying drawings.

FIG. 1 is a schematic, front view of a conventional optical device for reading/writing to an optical disk, and also showing part of an optical disk and essential optical paths.

FIG. 2 is an enlarged, isometric view of a conventional light emitting laser diode, showing a diverging path of a light beam emitted therefrom.

FIG. 3 is a graph showing a relationship between diverging angles of light emitted by a light emitting laser diode of the optical device of FIG. 1 (X-axis) versus light intensity output by a round collimating lens of the optical device (Y-axis).

FIGS. 4A and 4B are schematic, respectively top view and front view of an optical system for collimating elliptical light beams according to an exemplary embodiment of the present invention, showing essential optical paths thereof.

FIGS. 5A and 5B are schematic, respectively top view and front view of an optical system for collimating elliptical light beams according to another exemplary embodiment of the present invention, showing essential optical paths thereof.

FIG. 6 is a schematic, front view of an optical device for reading/writing to an optical disk, the optical device employing the optical system of FIG. 4, and also showing an optical disk and essential optical paths.

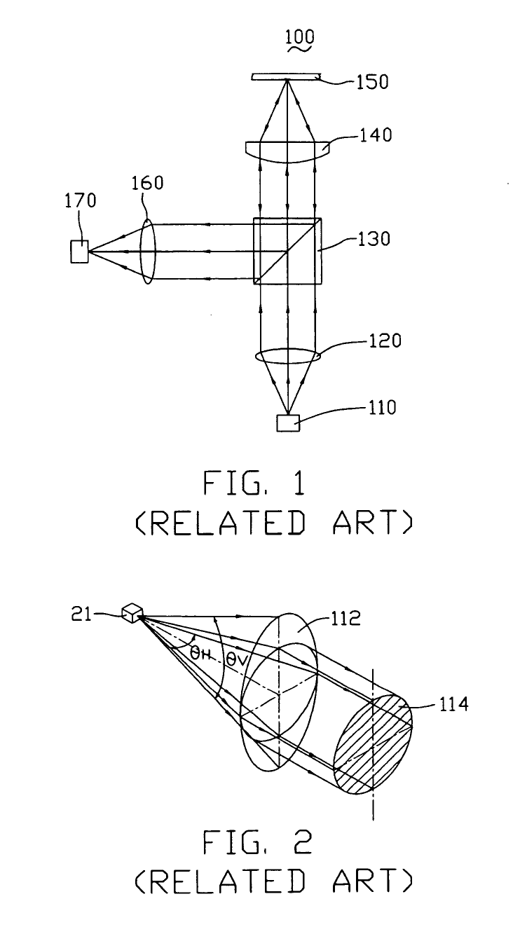

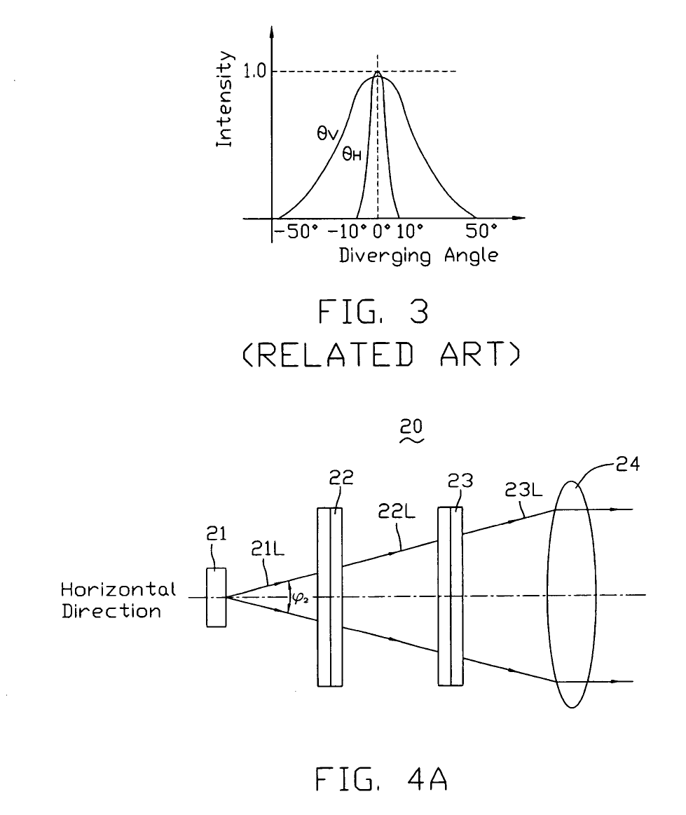

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF PREFERRED EMBODIMENTS

Reference will now be made to the drawings to describe in detail the preferred embodiments of the present optical system and an optical device using the same.

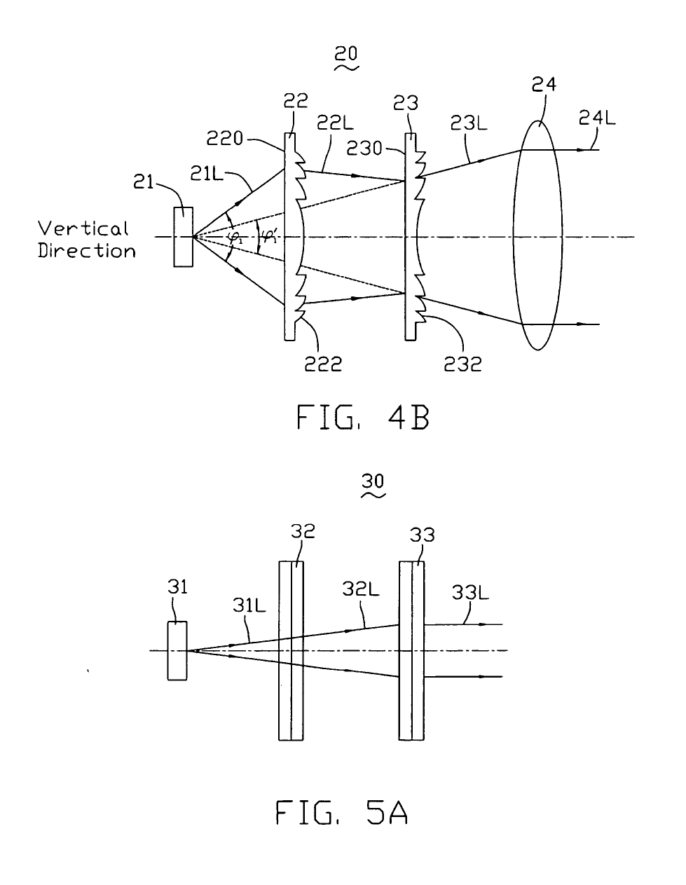

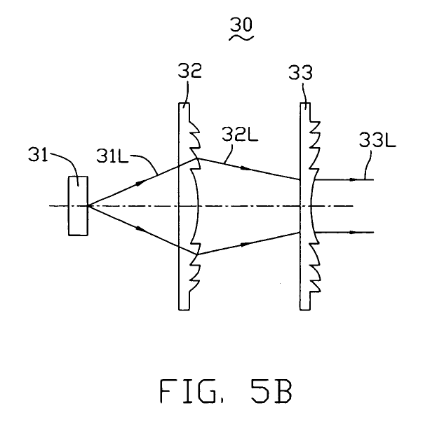

Referring to FIG. 4A, this is a schematic, top view of an optical system 20 for collimating elliptical divergent light beams into round parallel light beams according to an exemplary embodiment of the present invention. The optical system 20 includes a light source 21, a first lens 22, and a second lens 23 arranged in that sequence. The light source 21 is adapted for emitting an elliptical divergent light beam along a path coinciding with optical axes of the first lens 22, and the second lens 23. Any cross-section of the elliptical light beam emitted from the light source 21 defines a long axis and a short axis, which are perpendicular to each other. The elliptical light beam also defines different diverging angles in different directions. In the illustrated embodiment, the maximum diverging angle φ₁ is in a vertical direction and the minimum diverging angle φ₂ is in a horizontal direction. Thus in FIG. 4A, the long axis is perpendicular to the page, and the short axis is coplanar with the page. According to an embodiment shown in FIG. 4A, the optical system 20 is configured for collimating the diverged elliptical light beam emitted from the light source 21 to obtain a substantially round parallel light beam. In this exemplary embodiment, as shown in FIG. 4A, the minimum diverging angle φ₂ of the divergent elliptical light beam remains unchanged until it reaches the third lens 24 and is collimated thereby.

Referring to FIG. 4B, it illustrates a front view of the optical system 20 of FIG. 4A. The first lens 22 is a Fresnel lens having two surfaces 220 and 222 opposite to each other. At least one of the two surfaces 220 and 222 is configured as a Fresnel converging surface for converging light beams incident from the vertical direction. In the illustrated embodiment, the surface 222 is a converging surface, and the surface 220 is a flat surface. Thus the first lens 22 substantially functions as a converging lens in vertical directions. The second lens 23 is also a Fresnel lens having two surfaces 230 and 232 opposite to each other. At least one of the two surfaces 230 and 232 is configured as a Fresnel diverging surface for diverging light beams incident from the vertical direction. In the illustrated embodiment, the surface 232 is a diverging surface and the surface 230 is a flat surface. Thus the second lens 23 substantially functions as a diverging lens in vertical directions.

The light source 21 emits a divergent elliptical light beam 21L having a short axis configured in horizontal directions coplanar with the page of FIG. 4A. In horizontal directions, the first lens 22 and the second lens 23 do not change the diverging angles of the light beams transmitting therethrough.

In vertical directions, referring to FIG. 4B, the first lens 22 collimates the divergent elliptical light beam 21L, wherein both the long axis and the maximum diverging angle (Pi of the divergent elliptical light beam 21L are narrowed and a convergent elliptical light beam 22L is obtained thereby. The second lens 23 diverges the convergent elliptical light beam 22L enlarges the diverging angle of the convergent elliptical light beam 22L, thus obtaining a divergent light beam 23L thereby. In the exemplary embodiment, an imaginary diverging angle φ₁′ of the divergent light beam 23L is for example equal to the minimum diverging angle φ₂. Therefore, referring to FIGS. 4A and 4B, the second lens 23 outputs a round divergent light beam 23L.

According to the exemplary embodiment, the optical system 20 further includes a third lens 24. The third lens 24 is coaxially disposed with the first lens 22 and the second lens 23. In this exemplary embodiment, the third lens 24 is a round collimating lens having same cross-sections in both horizontal directions and vertical directions. The third lens 24 is configured for collimating the round divergent light beam 23L outputted from the second lens 23 into a parallel round light beam 24L.

It is to be noted that the third lens 24L can be any kind of lenses capable of collimating light beams in both vertical directions and horizontal directions, such lenses including spherical lenses, asperical lens, GRIN (gradient refractive index) lens, and Fresnel lens.

In use, the light source 21 emits a divergent elliptical light beam 21L having a short axis configured in horizontal directions coplanar with the page of FIG. 4A. The first lens 22 collimates the divergent elliptical light beam 21 into elliptical light beam 22L which is divergent in horizontal directions and convergent in vertical directions. The second lens 23 diverges the elliptical light beam 22L into divergent round light beam 23L. The third lens 24 converges the divergent light beam 23L in both horizontal directions and vertical directions, thus providing parallel light beam 24L having substantially round cross-sections and diverging angles approaching zero. The parallel round light beam 24L outputted from the third lens 24 is then ready for further use in a reading/writing operation.

The light source 21 is a sidelight emitting laser diode which has a rectangular waveguide type resonation cavity (not shown), from which the elliptical light beam 21L can be emitted. According to the exemplary embodiment, the first lens 22, the second lens 23 and the third lens 24 advantageously have a common optical axis, along which the divergent elliptical light beam 21 L emitted from the light source 21 is transmitted. The precise positions of the light source 21, the first lens 22, the second lens 23 and the third lens 24 relative to each other are determined according to need. For example, the optical system 20 may be structured so that the positions of any of lenses 22, 23 and 24 can be adjusted as required. That is, the positions of the lenses 22, 23 and 24 can be adjustable along the common optical axis. Thereby, the obtained parallel round light beam is tunable according to the requirements of any desired application.

According to an alternative embodiment of the present optical system 20 shown in FIGS. 4A and 4B, referring to FIGS. 5A and 5B, an alternative optical system 30 is illustrated. In this exemplary embodiment, the optical system 30 is similar with optical system 20 shown in FIGS. 4A and 4B, while the difference therebetween is that the optical system 30 employs a second lens 33 integrating functions of the second lens 23 and the third lens 24 of the optical system 20. In other words, when a light beam 32L outputted from a first lens 32 reaches the second lens 33, it has a round cross-section with equivalent short axis and long axis, and is convergent in vertical directions and divergent in horizontal directions. The second lens 33, in this exemplary embodiment, is adapted for convert such a light beam 32L into a parallel round light beam 33L. The second lens 33 can converge light beams transmitting therethrough in horizontal directions and diverge the light beams in vertical directions. In such a way, the parallel round light beam 33L outputted from the second lens 33 is then ready for further use in a reading/writing operation.

In summary, the optical system 20/30 is adapted for efficiently utilizing the light energy of a sidelight emitting laser diode 21/31. Thus in the exemplary embodiments, the efficiency of utilization of light emitted by the light source 21/31 is improved.

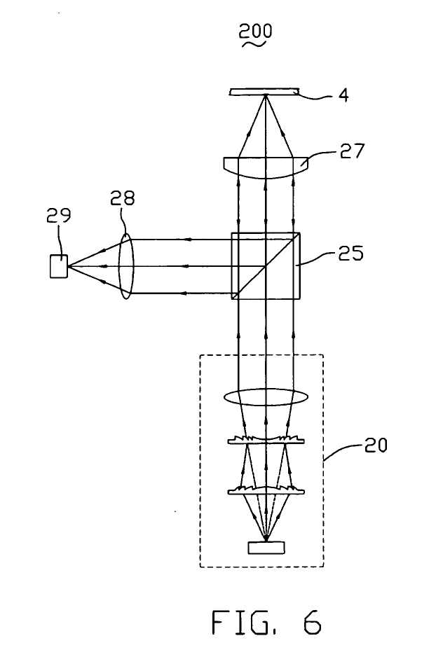

An exemplary optical device 200 employing the optical system 20 is shown in FIG. 6. It is to be noted, optical system 20 is described in FIG. 6 for the purpose of presenting optical system 20, without excluding any other optical systems, e.g., optical system 30, performing similar function. The optical device 200 is for reading/writing to an optical disk 4. The optical device 200 includes the optical system 20, a beam splitter 25, an object lens 27, a collimator 28, and an optoelectronic detector 29. The beam splitter 25 is configured for allowing light beams from a first direction to pass therethrough and for reflecting light beams from a second direction, the second direction being substantially opposite to the first direction. The object lens 27 is configured for focusing light beams passed therethrough. The optoelectronic detector 29 is configured for receiving a light beam, detecting information from the light beam, converting the information into electronic signals and outputting the electronic signals.

In operation, the optical system 20 provides a collimated parallel round light beam to the beam splitter 25. The parallel round light beam then passes through the beam splitter 25 to the object lens 27. The object lens 27 focuses the parallel light beam onto a point on the optical disk 4 set at a focal plane of the object lens, for reading data therefrom and/or writing data thereto. The light beam is modulated by the optical disk 4 according to the data recorded or the data to be written thereto, and then is reflected back to the object lens 27. The object lens 27 converts the light beam into a parallel light beam corresponding to information read from or written to the optical disk 4. The parallel light beam is then reflected by the beam splitter 25, and is then focused by the collimator 28 onto the optoelectronic detector 29. The optoelectronic detector 29 is adapted for detecting information from the light beam received, converting such information into electronic signals, and outputting the electronic signals.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. An optical system for collimating elliptical light beams, comprising:
a light source, adapted for providing a divergent elliptical light beam defining different diverging angles in different directions, wherein any cross-section of the elliptical light beam emitted from the light source defines a long axis and a short axis which are perpendicular to each other, the long axis corresponding to a vertical direction and a maximum diverging angle of the elliptical light beam, and the short axis corresponding to a horizontal direction and a minimum diverging angle of the elliptical light beam;
a first lens, configured as a converging lens in the vertical direction, the first lens converging the elliptical light beam in the vertical direction and remaining the elliptical light beam unchanged in the horizontal direction, thus obtaining a light beam that is convergent in the vertical direction and divergent in the horizontal direction; and
a second lens, configured as a diverging lens in the vertical direction, the second lens diverging the light beam from the first lens in the vertical direction, thus obtaining a round light beams having equal diverging angles in both the vertical directions and the horizontal directions.
wherein the light source, the first lens, the second lens are disposed in that sequence, and the first and second lenses commonly define a common optical axis along which the elliptical light beams travels.

2. The optical system as described in claim 1, wherein the second lens remains the diverging angle of the light beam from the first lens unchanged in the horizontal direction.

3. The optical system as described in claim 1, wherein the second lens converges the light beam from the first lens in the horizontal direction and outputs a parallel round light beam therefrom.

4. The optical system as described in claim 1, wherein the first lens is a Fresnel lens having two surfaces opposite to each other, at least one of the two surfaces being configured as a Fresnel converging surface configured for converging light beams incident thereon in the vertical direction.

5. The optical system as described in claim 1, wherein the second lens is a Fresnel lens having two surfaces opposite to each other, at least one of the two surfaces being configured as a Fresnel diverging surface configured for diverging light beams incident thereon in the vertical direction.

6. The optical system as described in claim 1 further comprising a third lens disposed coaxially with the first lens and the second lens for receiving and collimating the light beam outputted from the second lens into a parallel light beam.

7. The optical system as described in claim 6, wherein relative positions of the light source, the first lens, the second lens, and the third lens are adjustable along the common optical axis.

8. The optical system as described in claim 6, wherein the light source, the first lens, the second lens, and the third lens are arranged in that sequence.

9. The optical system as described in claim 1, wherein the light source is a sidelight emitting laser diode.

10. An optical device for reading/writing to an optical disk, comprising:
an optical system configured for outputting a round parallel light beam, the optical system comprising:
a light source, adapted for providing an elliptical light beam defining different diverging angles in different directions, wherein any cross-section of the elliptical light beam emitted from the light source defines a long axis and a short axis which are perpendicular to each other, the long axis corresponding to a vertical direction and a maximum diverging angle of the elliptical light beam, and the short axis corresponding to a horizontal direction and a minimum diverging angle of the elliptical light beam;
a first lens, configured as a converging lens in the vertical direction, the first lens converging the elliptical light beam in the vertical direction and remaining the elliptical light beam unchanged in the horizontal direction, thus obtaining a light beam that is convergent in the vertical direction and divergent in the horizontal direction; and
a second lens, configured as a diverging lens in the vertial direction, the second lens diverging the light beam from the first lens in the vertical direction, thus obtaining a round light beams having equal diverging angles in both the vertical directions and the horizontal directions.
wherein the optical centers of the first lens, the second lens are disposed in that sequence and commonly define a common optical axis along which the elliptical light beams travels;
a beam splitter, allowing light beams from a first direction to pass therethrough and for reflecting light beams from a second direction, the second direction being substantially opposite to the first direction;
an object lens for focusing parallel light beams to a point on an optical disk;
a collimator for collimating light beams passed therethrough; and
an optoelectronic detector, for receiving a light beam, detecting information from the light beam, converting the information into electronic signals, and outputting the electronic signals,
wherein the optical system, the beam splitter, the object lens, the collimator, and the optoelectronic detector are configured in a light path, so as to allow the round parallel light beam outputted from the optical system passes through the beam splitter, then is focused by the object lens onto a focal plane; then the focal plane reflects the focused light beam back to the object lens; the focused light beam is reverted by the object lens and incidents to round parallel light; then the beam splitter reflects the light beam to the collimator; and the collimator collimates the light beam to the optoelectronic detector.

11. An optical device for reading/writing to an optical disk, comprising:
an optical system comprising a sidelight emitting diode emitting an elliptical divergent light beam, and at least a Fresnel lens, wherein the optical system intermediately generates a light beam that is convergent in a first direction and divergent in a second direction, the first direction and the second direction being perpendicular to each other, and outputs a substantially round light beam having substantially equivalent short axis and long axis and equivalent diverging angles in both horizontal direction and vertical direction;
a beam splitter, allowing light beams from a first direction to pass therethrough and for reflecting light beams from a second direction, the second direction being substantially perpendicular to the first direction;
an object lens for focusing parallel light beams to a point on the optical disk;
a collimator for collimating light beams passed therethrough; and
an optoelectronic detector, for receiving a light beam, detecting information from the light beam, converting the information into electronic signals, and outputting the electronic signals,
wherein the optical system, the beam splitter, the object lens, the collimator and the optoelectronic detector are set in a manner that the round light beam outputted from the optical system travels in a sequence of the beam splitter, the object lens, the object lens, the beam splitter, the collimator, and the optoelectronic detector, in which the light beam outputted from the object lens is reflected by external reflective means of the optical disk back to the object lens.

12. The optical device as described in claim 11, wherein the round light beam outputted from the optical system is substantially a parallel light beam.
